(19) United States
(12) Patent Application Publication
(10) Pub. No.: US 2006/0224566 A1
(43) Pub. Date: Oct. 5, 2006

(54) Natural language based search engine and methods of use therefor

(76) Inventors: John S. Flowers, Mission, KS (US); Martin A. Quiroga, Kansas City, MO (US); Gordon H. Fischer, Kansas City, MO (US); John A. DeSanto, Kansas City, MO (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/096,118

(22) Filed: Mar. 31, 2005

(51) Int. Cl. G06F 17/30

(52) U.S. Cl. 707/3

(57) ABSTRACT

There is provided a search engine or other electronic search application that receives an inputted query in natural language. The search engine then analyzes the query in accordance with the syntactic relationships of the natural language in which it was presented, and generates a result to the query as output. The outputted result is typically an answer, in the form of a sentence or a phrase, along with the document from which the sentence or phrase is taken, including a hypertext link for the document.

### TECHNICAL FIELD

The present invention is directed to systems and methods for analyzing queries, placed into the system in natural language, and typically generating at least one result for the natural language query. The result is typically an answer, in the form of a sentence or a phrase, and the document from which it is taken, including a hypertext link for the document.

### BACKGROUND

As technology progresses, considerable amounts of information are becoming digitized, so as to be accessible through databases, servers and other storage media, along networks, including the Internet. When a user seeks certain information, it is essential to provide the most relevant information in the shortest time. As a result, search engines have been developed, to provide users with such relevant information.

Search engines are programs that search documents for specified keywords, and return a list of the documents where the keywords were found. The search engines may find these documents on public networks, such as the World Wide Web (WWW), newsgroups, and the like.

Contemporary search engines operate by indexing keywords in documents. These documents include, for example, web pages, and other electronic documents. Keywords are words or groups of words, that are used to identify data or data objects. Users typically enter words, phrases or the like, typically with Boolean connectors, as queries, on an interface, such as a Graphical User Interface (GUI), associated with a particular search engine. The search engine isolates certain words in the queries, and searches for occurrences of those keywords in its indexed set of documents. The search engine then returns one or more listings to the GUI. These listings typically include a hypertext link to a targeted web site, that if clicked by the user, will direct the browser associated with the user to the targeted web site.

Other contemporary search engines have moved away from keyword searching, by allowing a user to enter a query in natural language. Natural language, as used here and throughout this document (as indicated below), includes groups of words that humans use in their ordinary and customary course of communication, such as in normal everyday communication (general purpose communication) with other humans, and, for example, may involve writing groups of words in an order as though the writer was addressing another person (human). These systems that use natural language are either template based systems or knowledge based systems. These systems can operate together or independently of each other.

Template based systems employ a variety of question templates, each of which is responsible for handling a particular type of query. For example, templates may be instruction templates (How do I “QQ”?), price templates (How much does “RR” cost), direction templates (Where is “SS” located?), historical templates (When did “TT” occur), contemporary templates (What is the population of “UU”?, Who is the leader of “VV”?), and other templates, such as (What is the market cap of “WW”?, What is the stock price of “XX”?). These templates take the natural language entered and couple it with keywords, here for example, “QQ”-“XX” and may further add keywords, in order to produce a refined search for providing a response to the query.

Knowledge based systems are similar to template based systems, and utilize knowledge that has been previously captured to improve on searches that would utilize keywords in the query. For example, a search using the keyword “cats” might be expanded by adding the word “feline” from the knowledge base that cats are felines. In another example, the keyword “veterinarians” and the phrase “animal doctor” may be synomonous in accordance with the knowledge base.

However, both the template and knowledge based systems, although using some natural language, continue to conduct keyword based searches. This is because they continue to extract keywords from the natural language queries entered, and search based on these keywords. While the searches conducted are more refined than pure keyword based search engines, these systems do not utilize the natural language as it is written, and in summary, perform merely refined keyword searches. The results of such searches are inaccurate and have little if any chance of returning a precise answer for the query.

### SUMMARY

This document references terms that are used consistently or interchangeably herein. These terms, including variations thereof, are as follows.

“Natural language”, as stated above, includes groups of words that humans use in their ordinary and customary course of communication, such as in normal everyday communication (general purpose communication) with other humans, and, for example, may involve writing groups of words in an order as though the writer was addressing another person (human).

“Query” includes a request for information, for example, in the form of one or more, sentences, phrases, questions, and combinations thereof.

“Pull”, “pulls”, “pulled”, “pulling”, and variations thereof, include the request for data from another program, computer, server, or other computer-type device, to be brought to the requesting module, component, device, etc., or the module, component, device, etc., designated by the requesting device, module, etc.

“Documents” are any structured digitized information, including textual material or text, and existing as a single sentence or portion thereof, for example, a phrase, on a single page, to multiple sentences or portions thereof, on one or more pages, that may also include images, graphs, or other non-textual material.

“Sentences” include formal sentences having subject and verbs, as well as fragments, phrases and combinations of one or more words.

“Word” includes a known dictionary defined word, a slang word, words in contemporary usage, portions of words, such as “'s” for plurals, groups of letters, marks, such as “?”, “,”, symbols, such as “@”, and characters.

For purposes of explanation, concepts are used interchangeably with concept identifiers (CIDs), and concept links are used interchangeably with concept link identifiers (CLIDs).

“Modules”, are typically self contained components, that facilitate hardware, software, or combinations of both, for performing various processes, as detailed herein.

“Push”, “pushed”, “pushing” or variations thereof, include data sent from one module, component, device, etc, to another module, component, device, etc., without a request being made from any of the modules, components, devices, etc., associated with the transfer of the data.

“Statement”, is a set of concept links (concept link identifiers) that corresponds to a parse of a particular sentence (from its natural language).

A “query statement” is a set of concept links (concept link identifiers) that correspond to the parse of the query.

A “master set” is all of the valid concept link identifiers (CLIDs) from a query statement.

A “power set” is written as the function P(S), and is representative of the set of all subsets of “S”, where “S” is the master set.

“Degree” or “degrees” is the number of concept links in a set.

The present invention improves on the contemporary art, as it provides a search engine and associated functionalities, that operate on natural language queries, and utilize the syntactic relationships between the natural language elements of the query, to typically return at least one result to the user.

The system of the invention is also a cumulative system, that continuously builds its data store, from which query answers are obtained. As time progresses, the data store becomes increasingly larger, increasing the chances for a more precise answer to queries entered by users.

The system of the invention is suitable for private networks, such as with enterprises, as well as public networks, such as wide area networks, for example, the Internet. The invention is also operable with combinations of private and public networks.

An embodiment of the invention is directed to a method for analyzing a query. The method includes, receiving a query in natural language, and, providing at least one response to the query in accordance with the relationships of the words to each other in natural language, of the query.

Another embodiment of the invention is directed to a search engine. The search engine has a first component that receives a query in natural language. It also has a second component that provides at least one response to the query in accordance with the relationships of the words to each other in natural language, of the query.

An embodiment of the invention is directed to a method for isolating data from a corpus. The method includes processing at least a portion of the corpus into a first collection of syntactic relationships, processing at least one query into a second collection of syntactic relationships, and, comparing the second collection of syntactic relationships to the first collection of syntactic relationships. If a match of syntactic relationships between the collections is found, the matching collection of syntactic relationships in the first collection is isolated. The data, for example, sentences, documents, and the like, typically in natural language, are returned to the party (typically, the computer or computer-type device associated with the party) who requested the data isolated from the corpus.

Another embodiment of the invention is directed to a method for providing at least one response to at least one query in natural language. The method includes populating a data store by obtaining documents from at least a portion of a corpus, isolating sentences from the documents, parsing the sentences into linked pairs of words in accordance with predetermined relationships, assigning concept identifiers to each word of the linked pair of words, assigning concept link identifiers to each pair of concept identifiers corresponding to each linked pair of words, and, combining the concept link identifiers for each sentence into a statement. An inputted query in natural language is received. The inputted query is parsed into linked pairs of words in accordance with predetermined relationships, concept identifiers are assigned to each word of the linked pair of words, concept link identifiers are assigned to each pair of concept identifiers corresponding to each linked pair of words, and, the concept link identifiers are combined into a query statement. The query statement and the statements in the data store are analyzed for matches between concept link identifiers. If there are matches, the matching statements in the data store are isolated. At least one sentence corresponding to at least one isolated statement in the data store is typically provided to a predetermined location as a response to the natural language query.

Another embodiment of the invention is directed to a method for analyzing a query to a search engine. The method includes creating related pairs of words in the query, and assigning concept identifiers to each of the words in each of the related pairs of words. Pairs of concept identifiers are then created by applying the assigned concept identifiers to each word in the related pairs of words. Concept link identifiers are assigned to each pair of concept identifiers, and all of the concept link identifiers are combined into a query statement.

All of the concept link identifiers of the query statement define a master set, where N is the number of concept link identifiers in the master set. A power set is created from the master set. Creation of the power set involves creating a plurality of subsets from the master set, where the plurality of subsets define members of the power set, and the power set includes at least one member of N concept link identifiers, and at least N members of one concept link identifier.

The members of the power set are analyzed against statements from a data store, in a structured representation. The statements from the data store, having the greatest number of concept link identifiers, that match all of the concept link identifiers of the highest degreed member (member set) of the power set, is the highest ranked statement(s). The highest ranked statement(s) is/are typically returned as results or answers, to the query made to the search engine of the invention.

Another embodiment of the invention is directed to a method for analyzing a query to a search engine, made in natural language. The method includes creating related pairs of words from the natural language of the query, and assigning concept identifiers to each of the words in each of the related pairs of words. Pairs of concept identifiers are then created, by applying the assigned concept identifiers to each word in the related pairs of words. Concept link identifiers are assigned to each pair of concept identifiers, and all of the concept link identifiers are combined into a query statement.

All of the concept link identifiers of the query statement define a master set, where N is the number of concept link identifiers in the master set. A power set is created from the master set. Creation of the power set involves creating a plurality of subsets from the master set, where the plurality of subsets define members of the power set, and the power set includes at least one member of N concept link identifiers, and at least N members of one concept link identifier.

The members of the power set are analyzed against statements from a data store, in a structured representation. The statements from the data store, having the greatest number of concept link identifiers, that match all of the concept link identifiers of the highest degreed member (member set) of the power set, is the highest ranked statement(s). The highest ranked statement(s) is/are typically returned as results or answers in natural language, to the query made to the search engine of the invention.

Another embodiment of the invention is directed to a method for identifying a document from syntactic relationships. The method includes electronically maintaining a document database, identifying documents, electronically maintaining a sentences database, identifying sentences of each of the documents, and, electronically maintaining a syntactic relationships database, identifying collections of syntactic relationships between pairs of words formed from the words of each of the sentences. Each of the databases is electronically linked, such that when at least one collection of syntactic relationships is isolated, the corresponding sentence in the sentence database is isolated, and the corresponding document in the document database is isolated from the isolated sentence in the sentence database. The collections of syntactic relationships define statements, that include concept link identifiers. The concept link identifiers are formed from pairs of concept identifiers. Each word of each pair of words has an assigned concept identifier.

Another embodiment of the invention is directed to an architecture for isolating data from a corpus. The architecture includes, at least one data storage unit including at least one database, a database population module coupled to the at least one data storage unit, and, an answer module coupled to the at least one data storage unit. The database population module is configured for processing at least a portion of the corpus into at least one first collection of syntactic relationships, and, storing the at least one first collection of syntactic relationships in the at least one data storage unit. The answer module is configured for, processing at least one query into at least one second collection of syntactic relationships, and, comparing the at least one second collection of syntactic relationships to the at least one first collection of syntactic relationships.

### BRIEF DESCRIPTION OF THE DRAWINGS

Attention is now directed to the drawing figures, where corresponding or like numerals and/or characters, indicate corresponding or like components. In the drawings:

FIG. 1A is a schematic diagram of the system of an embodiment of the invention in an exemplary operation in an enterprise or private network, such as a local area network (LAN);

FIG. 1B is a schematic diagram of the system of an embodiment of the invention in an exemplary operation in a public network, such as the Internet;

FIG. 2 is a schematic diagram of the architecture for the system of FIGS. 1A and 1B;

FIG. 3 is a schematic diagram of the architecture detailing the operation of the database population module;

FIG. 4 is a schematic representation of a document produced in accordance with an embodiment of the invention;

FIGS. 5A and 5B are a flow diagram of a process performed by the sentence module in accordance with an embodiment of the invention;

FIG. 6 is flow diagram detailing the sub process of generating a concept list in FIGS. 5A and 5B;

FIGS. 7A and 7B are a flow diagram detailing the sub process of generating concept links in FIGS. 5A and 5B;

FIG. 8 is a table of stop words;

FIG. 9 is a schematic diagram of the architecture for the operation of the answer module of the architecture of FIG. 2;

FIGS. 10A and 10B for a flow diagram of a process performed by the answer module in accordance with the present invention;

FIGS. 11A-11C are tables illustrating results of sub processes of FIGS. 10A and 10B; and,

FIG. 12 is a diagram of the data structure for the system of the invention.

Appendices A-D are also attached to this document.

### DETAILED DESCRIPTION

The invention is directed to systems and methods for performing search engine functions and applications. In particular, the invention is directed to search engines that perform searches based on the natural language and its associated syntax of the query, that has been entered into the system, and for which a search result will be produced. Throughout this document (as indicated above), “query” includes a request for information, for example, in the form of one or more, sentences, phrases, questions, and combinations thereof.

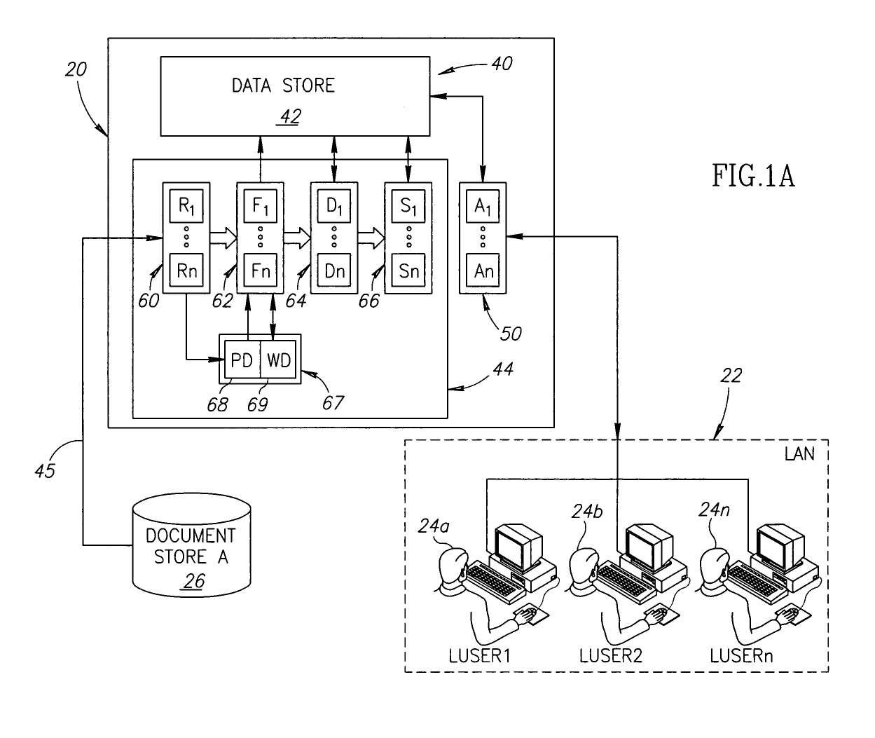

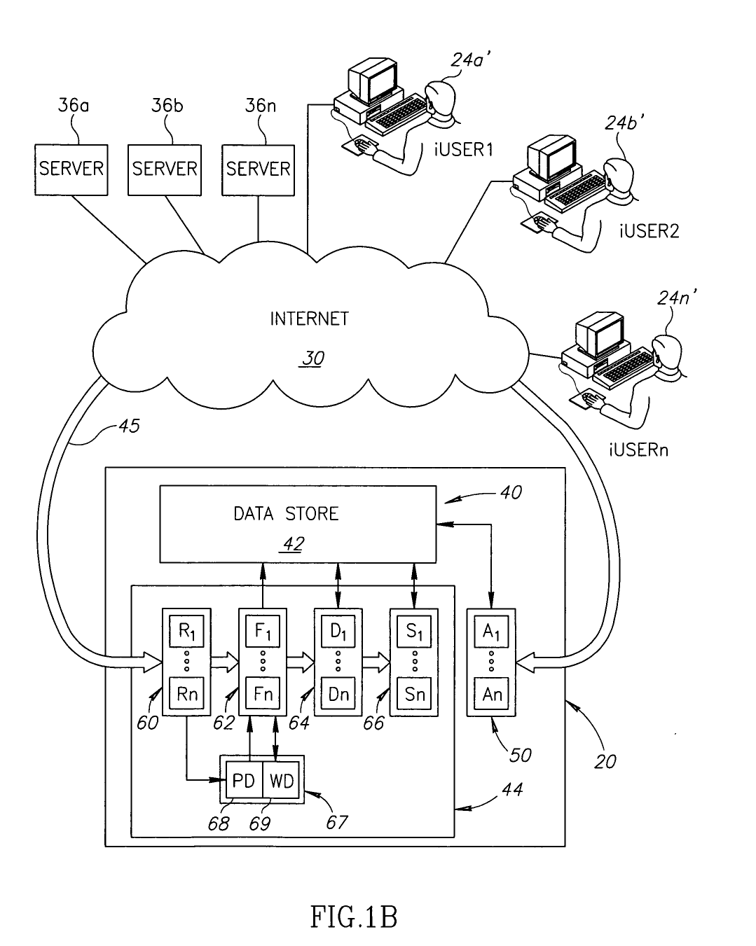

FIGS. 1A and 1B detail the system of the invention, in an exemplary configuration as a server 20 or other hosting system of one or more components, in exemplary operations. The server 20 is common to the systems of FIG. 1A and FIG. 1B, except where specifically modified to accommodate the private or local area network (LAN) of FIG. 1A, and the public or wide area network (WAN) of FIG. 1B. Alternately, the server 20 can be modified to work with networks that are partially private and partially public.

FIG. 1A shows the server 20 operating in a closed system (private network), such as a local area network (LAN) 22, being accessed by users 24a, 24b, 24n (LUSER1-LUSERn). The server 20 receives data from document storage media, for example, the document store 26. This setting is typical of an enterprise setting.

FIG. 1B shows the server 20 operating in a publicly accessible network, for example, with a wide area network (WAN), such as the Internet 30. The server is accessed by one or more users 24a′, 24b′, 24n′ (iUSER1-iUSERn), and the server 20 is linked to the Internet 30 to obtain feeds from sources linked to the Internet 30, for example, such as target Hypertext Transfer Protocol (HTTP) or File Transfer Protocol (FTP) servers 36a-36n. As used in this document “link(s)”, “linked” and variations thereof, refer to direct or indirect electronic connections that are wired, wireless, or combinations thereof.

The server 20 is the same in FIGS. 1A and 1B, except for the links to the sources and network connections. The server 20 is formed of an exemplary architecture 40 for facilitating embodiments of the invention. The architecture 40 is typically on a single server, but is also suitable to be on multiple servers and other related apparatus, with components of the architecture also suitable for combination with additional devices and the like.

The server 20 is typically a remote computer system that is accessible over a communications network, such as the Internet, a local area network (LAN), or the like. The server serves as an information provider for the communications network.

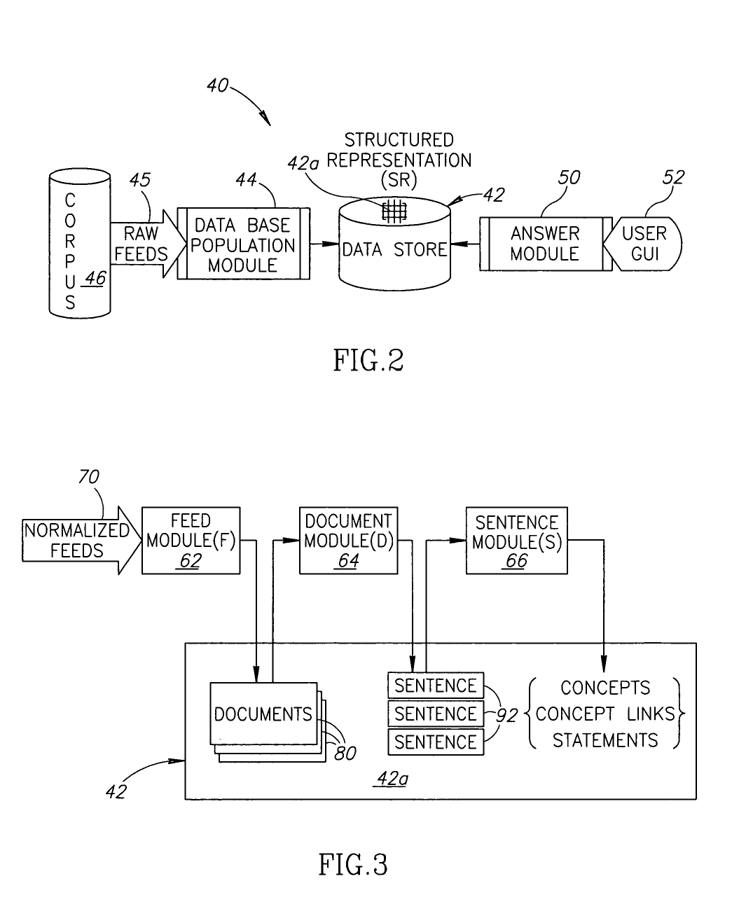

Turning also to FIG. 2, the architecture 40 may be, for example, an application, such as a search engine functionality. The architecture 40 includes a data store 42, that typically includes one or more databases or similar data storage units. A database population module 44 populates (provides) the data store 42 with content, by pulling data from raw feeds 45 (FIG. 2), and processing the pulled data. The database population module 44 receives raw feeds 45, by pulling them from a corpus 46 or a portion of the corpus 46.

Throughout this document (as indicated above), the terms “pull”, “pulls”, “pulled”, “pulling”, and variations thereof, include the request for data from another program, computer, server, or other computer-type device, to be brought to the requesting module, component, device, etc., or the module, component, device, etc., designated by the requesting device, module, etc.

The corpus 46 is a finite set of data at any given time. For example, the corpus 46, may be text in its format, and its content may be all of the documents of an enterprise in electronic form, a set of digitally encoded content, data from one or more servers, accessible over networks, such as the Internet, etc. Raw feeds 45 may include, for example, news articles, web pages, blogs, and other digitized and electronic data, typically in the form of documents.

Throughout this document (as indicated above), “documents” are any structured digitized information, including textual material or text, existing as a single sentence or portion thereof, for example, a phrase, on a single page, to multiple sentences or portions thereof, on one or more pages, that may also include images, graphs, or other non-textual material. “Sentences” include formal sentences having subject and verbs, as well as fragments, phrases and combinations of one or more words. Also, a “word” includes a known dictionary defined word, a slang word, words in contemporary usage, portions of words, such as “'s” for plurals, groups of letters, marks, such as “?”, “,”, symbols, such as “@”, and characters.

The pulled data is processed by the database population module 44, to create a structured representation (SR) 42a, that is implemented by the data store 42. The structured representation (SR) 42a includes normalized documents (an internally processed document into a format usable by the document module (D) 64, as detailed below), the constituent sentences from each normalized document, and collections of syntactic relationships derived from these sentences. Syntactic relationships include, for example, syntactic relationships between words. The words originate in documents, that are broken into constituent sentences, and further broken into data elements including concepts, concept links (groups of concepts, typically ordered pairs of concepts), and statements (groups of concept links).

As detailed below, concepts and concept links will be assigned identifiers. In particular, each concept is assigned a concept identifier (CID), and each concept link, formed by linked pairs of concept identifiers (CIDs), in accordance with the relational connectors of the Link Grammar Parser (LGP), as detailed below, is assigned a concept link identifier (CLID). Accordingly (as indicated above), for purposes of explanation, concepts are used interchangeably with concept identifiers (CIDs), and concept links are used interchangeably with concept link identifiers (CLIDs).

An answer module (A) 50 is also linked to a graphical user interface (GUI) 52 to receive input from a user. The answer module (A) 50 is also linked to the structured representation (SR) 42a, as supported by the data store 42.

Turning back to FIGS. 1A and 1B, the database population module 44 includes retrieval modules (R₁-Rₙ) 60, feed modules (F₁-Fₙ) 62, that are linked to document modules (D₁-Dₙ) 64, that are linked to sentence modules (S₁-Sₙ) 66. The retrieval modules (R₁-Rₙ) 60 are linked to storage media 67, that is also linked to the feed modules (F₁-Fₙ) 62. The feed modules (F₁-Fₙ) 62, document modules (D₁-Dₙ) 64 and sentence modules (S₁-Sₙ) 66 are linked to the data store 42. “Modules”, as used throughout this document (as indicated above), are typically self contained components, that facilitate hardware, software, or combinations of both, for performing various processes, as detailed herein.

The storage media 67 may be any known storage for data, digital media and the like, and may include Redundant Array of Independent Disks (RAIDs), local hard disc(s), and sources for storing magnetic, electrical, optical signals and the like. The storage media 67 is typically divided into a processing directory (PD) 68 and a working directory (WD) 69.

The retrieval module (R₁-Rₙ) 60 typically receives data from external sources, for example, document stores, such as the store 26 (FIG. 1A), from the Internet 30 (FIGS. 1A and 1B), etc., in the form of raw feeds 45. The retrieval module (R₁-Rₙ) 60 places or pushes the retrieved data in the processing directory (PD) 68. An individual feed module (F₁-Fₙ) 62 moves (pushes) data from the processing directory (PD) 68, to a unique location in the working directory (WD) 69, exclusive to the particular feed module (F₁-Fₙ) 62. Each individual feed module (F₁-Fₙ) pulls data from its unique location in the working directory (WD) 69, for processing, as a normalized feed 70 (FIG. 3). The unique locations in the working directory (WD) 69, corresponding to an individual feed module (F₁-ₙ) 62, preserve the integrity of the data in the file and/or document.

Throughout this document (as indicated above), “push”, “pushed”, “pushing” or variations thereof, includes data sent from one module, component, device, etc, to another module, component, device, etc., without a request being made from any of the modules, components, devices, etc., associated with the transfer of the data.

Raw feeds 45 are typically retrieved and stored. If the raw feed 45 exceeds a programmatic threshold in size, the raw feed 45 will be retrieved in segments, and stored in accordance with the segments, typically matching the threshold size, on the processing directory (PD) 68. The processing directory (PD) 68, is, for example, storage media, such as a local hard drive or network accessible hard drive. The raw feeds 45, typically either a single file or in segments, may also be archived on a file system, such as a hard drive or RAID system. The sources of the raw feeds 45 are typically polled over time for new raw feeds. When new raw feeds are found, they are retrieved (pulled) and typically stored on the processing directory (PD) 68.

Specifically, the feed modules (F₁-Fₙ) 62 are linked to the data store 42 to store processed documents pulled into the system. The feed modules (F₁-Fₙ) 62 parse feeds into documents and push the documents into the data store 42. The documents that are inserted (pushed) into the data store 42a re known as unprocessed documents.

The document modules (D₁-Dₙ) 64 are linked to the data store 42 to pull documents from the data store 42 and return extracted sentences from the documents to the data store 42. Typically, the document modules (D₁-Dₙ) 64 obtain an unprocessed document from the data store 42, and extract the sentences of the document. The documents are then marked as processed, and the extracted sentences are pushed into the data store 42. These sentences, pushed into the data store 42, by the document modules (D₁-Dₙ) 64, are known as unprocessed sentences.

The sentence modules (S₁-Sₙ) 66 are linked to the data store 42 to pull the unprocessed sentences from the data store 42. The unprocessed sentences are processed, and marked as processed, and pushed into the structured representation (SR) 42a of the data store 42. Processing of the unprocessed sentences results in collections of syntactic relationships being obtained, that are returned to the data store 42 to increase the structured representation (SR) 42a and/or increment indices on existing collections of syntactic relationships.

The retrieval modules (R₁-Rₙ) 60, feed modules (F₁-Fₙ) 62, document modules (D₁-Dₙ) 64, and sentence modules (S₁-Sₙ) 66 operate independently of each other. Their operation may be at different times, contemporaneous in time, or simultaneous, depending on the amount of data that is being processed. The feed modules (F₁-Fₙ) 62, place documents (typically by pushing) into the data store 42. One or more document modules (D₁-Dₙ) 64 query the data store 42 for documents. If documents are in the data store 42, each document module (D₁-Dₙ) 64 pulls the requisite documents.

The documents are processed, typically by being broken into sentences, and the sentences are returned (typically by being pushed) to the data store 42. One or more sentence modules (S₁-Sₙ) 66 query the data store 42 for sentences. If unprocessed sentences are in the data store 42, as many sentence modules (S₁-Sₙ) 66 as are necessary, to pull all of the sentences from the data store 42, are used. The sentence modules (S₁-Sₙ) 66 process the sentences into syntactic relationships, and return the processed output to the data store 42, to increase the structured representation (SR) 42a and/or increment indices on existing syntactic relationships.

The database population module 44 includes all of the functionality required to create the structured representation (SR) 42a, that is supported in the data store 42. The database population module 44 is typically linked to at least one document storage unit 26, over a LAN or the like, as shown in FIG. 1A, or a server, such as servers 36a-36n, if in a public system such as the Internet 30, as shown in FIG. 1B, in order to pull digitized content (raw feeds 45), that will be processed into the structured representation (SR) 42a.

FIG. 3 shows an operational schematic diagram of the database population side of the architecture 40. The database population sequence, that occurs in the database population module 44, forms the structured representation (SR) 42a. For example, one or more normalized feeds 70 are pulled into a feed module (F) 62. Normalized feeds are feeds that have been stored in the working directory (WD) 69. In this figure, a single feed module (F) 62, a single document module (D) 64 and a single sentence module (S) 66 are shown as representative of the respective feed modules (F₁-Fₙ), document modules (D₁-Dₙ) and sentence modules (S₁-Sₙ), to explain the database (data store 42 ) population sequence.

Prior to the feed module (F) 62 retrieving the normalized feed 70 from the working directory (WD) 69, the retrieval module 60 (FIGS. 1A and 1B), has translated the raw feeds 45 (FIGS. 1A, 1B and 2 ) into files in formats usable by the feed module (F) 62. The retrieval module (R) 60 saves the now-translated files typically on the processing directory (PD) 68 or other similar storage media (PD 68 is representative of multiple processing directories). For example, Extensible Markup Language (XML) is one such format that is valid for the feed module(s) (F) 62.

The feed module (F) 62, is given the location of the processing directory (PD) 68, and will move a file or document from the processing directory (PD) 68 to a unique working directory (WD) 69 (WD 69 is representative of multiple working directories) for each individual running feed module (F) 62. The feed module (F) 62 then opens the file or document, and extracts the necessary document information, in order to create normalized document type data, or normalized documents 80.

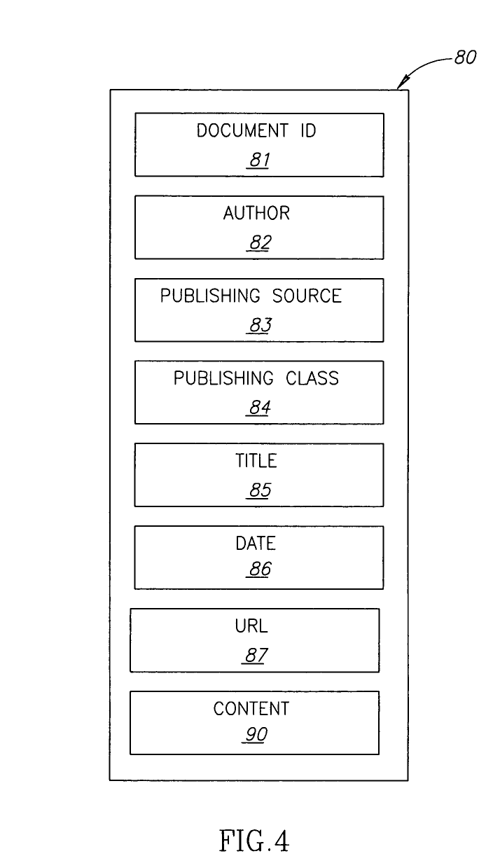

FIG. 4 shows a normalized document 80 in detail, and attention is now directed to this Figure. The document 80, typically includes fields, that here, include attributes, for example, Document Identification (ID) 81, Author 82, Publishing Source 83, Publishing Class 84, Title 85, Date 86, Uniform Resource Locator (URL) 87, and content 90 (typically including text or textual material in natural language). Other fields, including additional attributes and the like are also permissible, provided they are recognized by the architecture 40.

The feed module (F) 62 isolates each field 81-87 and 90 in the document 80. Each field 81-87 and 90 is then stored in the structured representation (SR) 42a of the data store 42, as a set of relational records (records based on the Relational Database Model). The fields 81-87 and 90 represent attributes, for the document 80 that remain stored for the purpose of ranking each document against other documents. The content from the content field 90 is further processed into its constituent sentences 92 by the document module (D) 64.

The document module (D) 64, splits the content of the content field 90 into valid input for the sentence module (S) 66, or other subsequent processing modules. For example, valid input includes constituent sentences 92 that form the content field 90. The content is split into sentences by applying, for example, Lingua::EN::Sentence, a publicity available PERL Module, attached hereto as Appendix A, and publicly available over the World Wide Web at www.cpan.org. To verify that only valid sentences have been isolated, the sentences are subjected to a byte frequency analysis. An exemplary byte frequency is detailed in M. McDaniel, et al., Content Based File Type Detection Algorithms, in Proceedings of the 36^{th} Hawaii International Conference on System Sciences, IEEE server 2002, this document incorporated by reference herein.

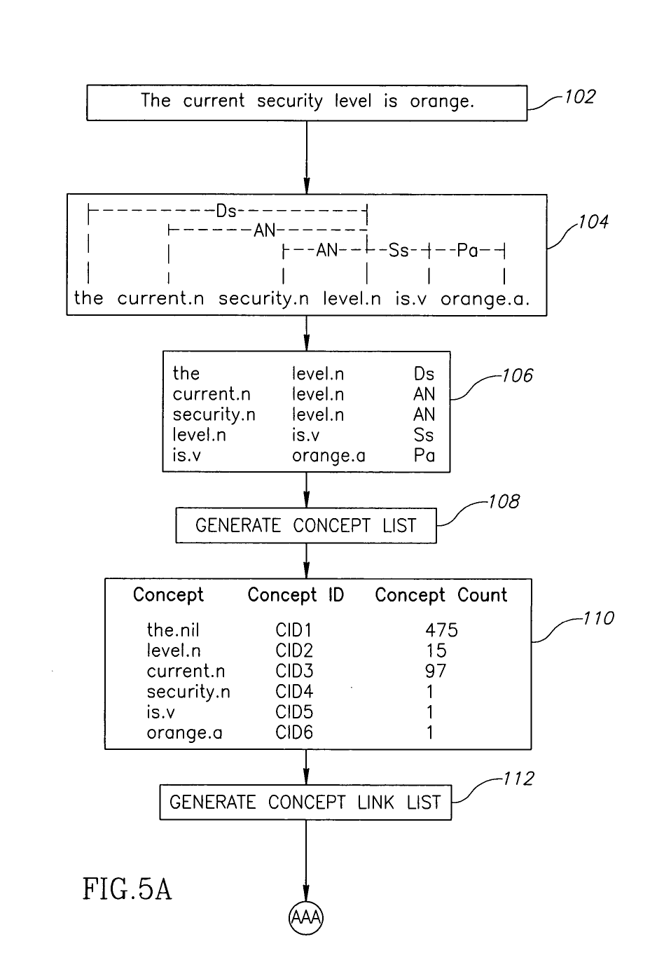

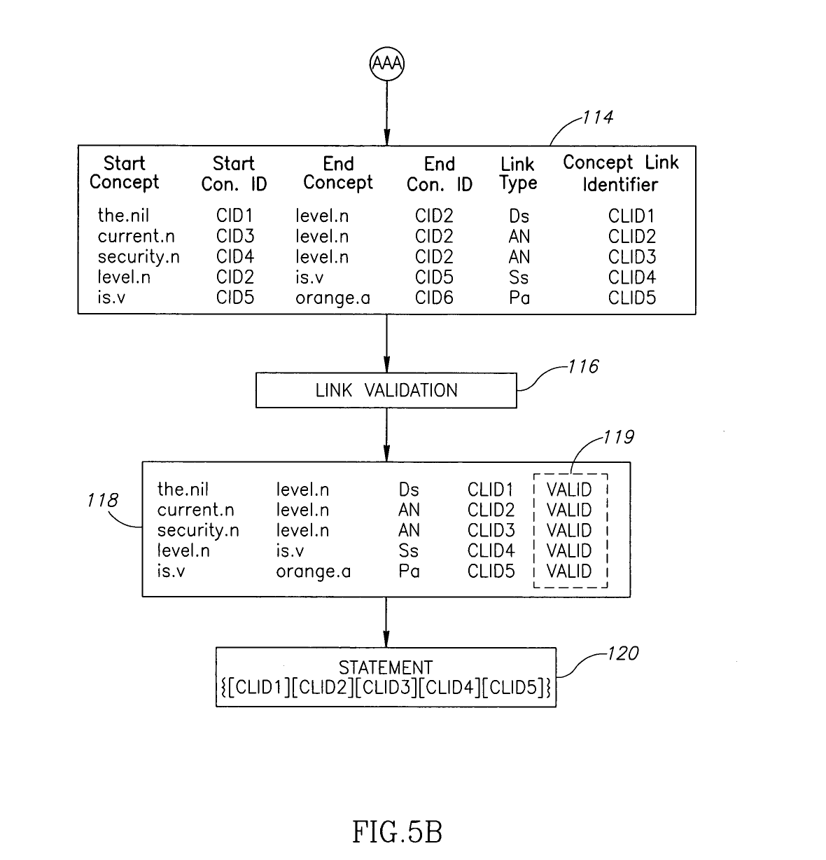

Turning also to FIGS. 5A-8, and specifically to FIGS. 5A and 5B (an exemplary operation of the sentence module (S) 66 ), the sentence module (S) 66 parses the sentence 92 into its grammatical components. These grammatical components may be defined as the constituent words of the sentence, their parts of speech, and their grammatical relationship to other words in the same sentence, or in some cases their relationships to words in other sentences, for example, pronouns.

The parsing is performed, for example, by the Link Grammar Parser (LGP or LGP parser), Version 4.1b, available from Carnegie Mellon University, Pittsburgh, Pa., and detailed in the document entitled: An Introduction to the Link Grammar Parser, attached as Appendix B, hereto, and in the document entitled: The Link Parser Application Program Interface (API), attached as Appendix C hereto, both documents also available on the World Wide Web at http://www.link.cs.cmu.edu/link/dict/introduction.html. The LGP parser outputs the words contained in the sentence, identifies their parts of speech (where appropriate), and the grammatical syntactic relationships between pairs of words, where the parser recognizes those relationships.

The sentence module (S) 66, includes components that utilize the parse (parsed output), and perform operations on the parsed sentences or output to create the structured representation (SR) 42a. The operation of the sentence module (S) 66, including the operations on the parsed sentences, results in the structured representation (SR) 42a, as detailed below.

The sentence module (S) 66 uses the LGP (detailed above) to parse each sentence of each normalized document 80. The output of each parse is a series of words or portions thereof, with a concept sense, as detailed in the above mentioned document entitled: An Introduction to the Link Grammar Parser (Appendix B), with the words paired by relational connectors, or link types, as assigned by the LGP. These relational connectors or link types, as well as all other relational connectors or link types, are in described in the document entitled: Summary of Link Types, attached as Appendix D hereto.

In an exemplary operation of the sentence module (S) 66, the sentence module (S) 66 receives sentences from documents, typically one after another. An exemplary sentence received in the sentence module (S) 66 may be, the sentence 102 from a document, “The current security level is orange.” The sentence 102 is parsed by the LGP, with the output of the parse shown in box 104.

In box 104, the output of the parsing provides most words in the sentence with a concept sense. While “the” does not have a concept sense, “current”, “security” and “level” have been assigned the concept sense “n”, indicating these words are nouns. The word “is” has a concept sense “v” next to it, indicating it is a verb, while “orange” has a concept sense “a” next to it, indicating it is an adjective. These concept senses are assigned by the LGP for purposes of its parsing operation. Assignments of concept senses by the LGP also include the failure to assign concept senses.

The output of the parsing also provides relational connectors between the designated word pairs. In box 104, the relational connectors or link types are “Ds”, “AN” (two occurrences), “Ss” and “Pa”. The definitions of these relational connectors are provided in Appendix C, as detailed above.

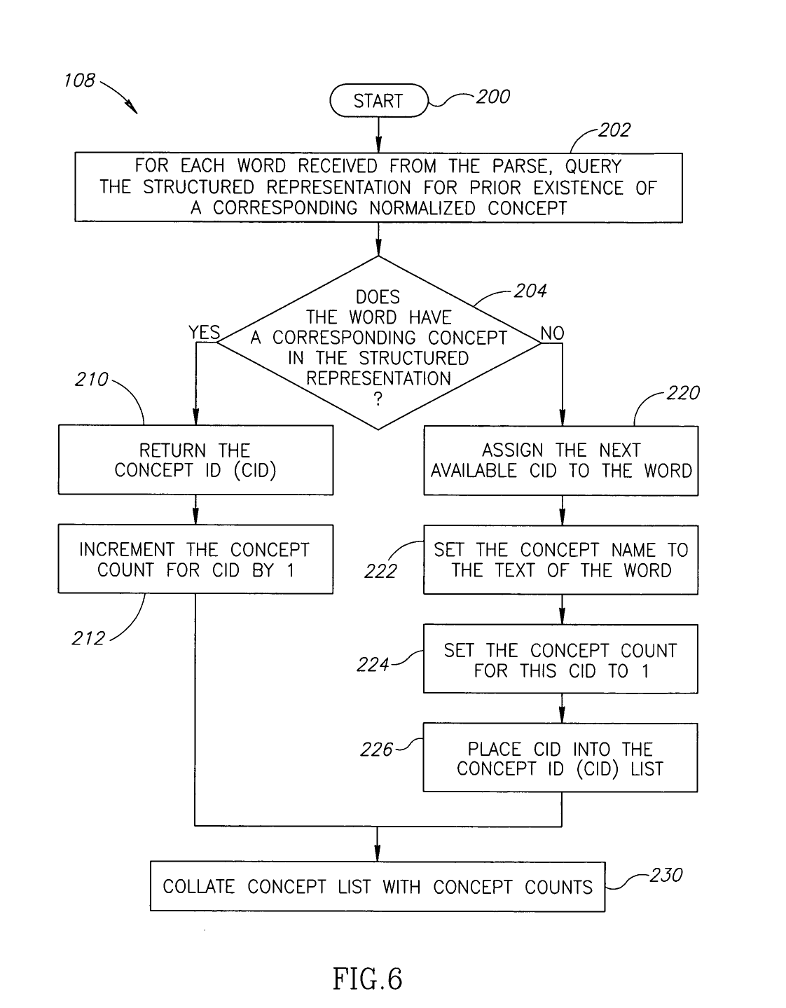

The LGP parse of box 104 is then made into a table 106. The table 106 is formed by listing word pairs, as parsed in accordance with the LGP parse, each word with its concept sense (if it has a concept sense as per the LGP parse) and the LGP link type connector. The process now moves to box 108, where a concept list 110 is generated, the process of generating the concept list described by reference to the flow diagram of FIG. 6, to which attention is now directed.

In FIG. 6, in block server 200, a formatted parse from the LGP is received, and the parsed output is typically compiled into a table 106 (FIG. 5A). The compiling typically involves listing the parsed output as word pairs with their concept senses and link type connectors in an order going from left to right in the parsed output. Moving to block server 202, each word from the LGP parse, typically the table of the parse, such as the table 106, is queried against the structured representation (SR) 42a for a prior existence of the corresponding normalized concept. At block server 204, a decision is made whether or not the requisite word has a corresponding concept in the structured representation (SR) 42a.

If the word matches a concept in the structured representation (SR) 42a, the process moves to the sub process of block 210. If the word does not match any concept in the structured representation (SR) 42a, the process moves to the sub process of block server 202.

At block 210, the word exists as a concept, as a matching word and concept sense, with a concept identifier (CID) was found in the structured representation (SR) 42a. Accordingly, the matching word with its concept sense is assigned the concept identifier (CID) of the matching (existing) word and its concept sense. The concept count in the database, for example, in the data store 42 or other storage media linked thereto, for this existing concept identifier (CID), is increased by 1, at block 212. The process now moves to block 230.

Turning to block server 202, the word does not exist as a concept in the structured representation (SR) 42a. This is because a matching word and concept sense, with a concept identifier (CID), has not been found in the structured representation (SR) 42a. Accordingly, the next available concept identifier (CID) is assigned to this word. By assigning the word a concept identifier (CID), the word is now a concept, with the concept identifier being assigned in ascending sequential order. Also, if the LGP fails to provide a concept sense for the word, the word is assigned the default value of “nil”. The concept sense “nil” is a place holder and does not serve any other functions.

A concept identifier (CID) is set to the text of the word, for the specific concept identifier (CID), at block 222. At block 224, the concept count for this new concept identifier is set to 1. The concept identifier (CID), developed at block server 202, is now added or placed into to the list of concept identifiers (CIDs), such as the list 110, at block 226. The process moves to block 230.

At block 230, the words with their concept senses, corresponding concept identifiers (CIDs) and concept counts, are now collated into a list, such as a completed list for the sentence, such as the list 110.

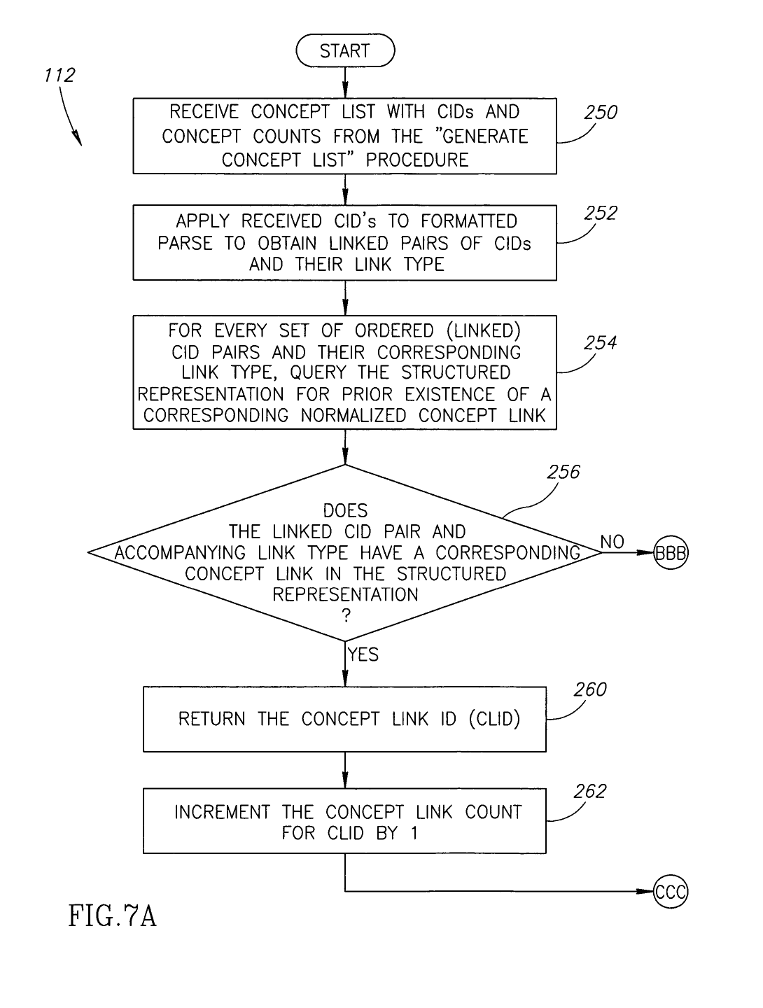

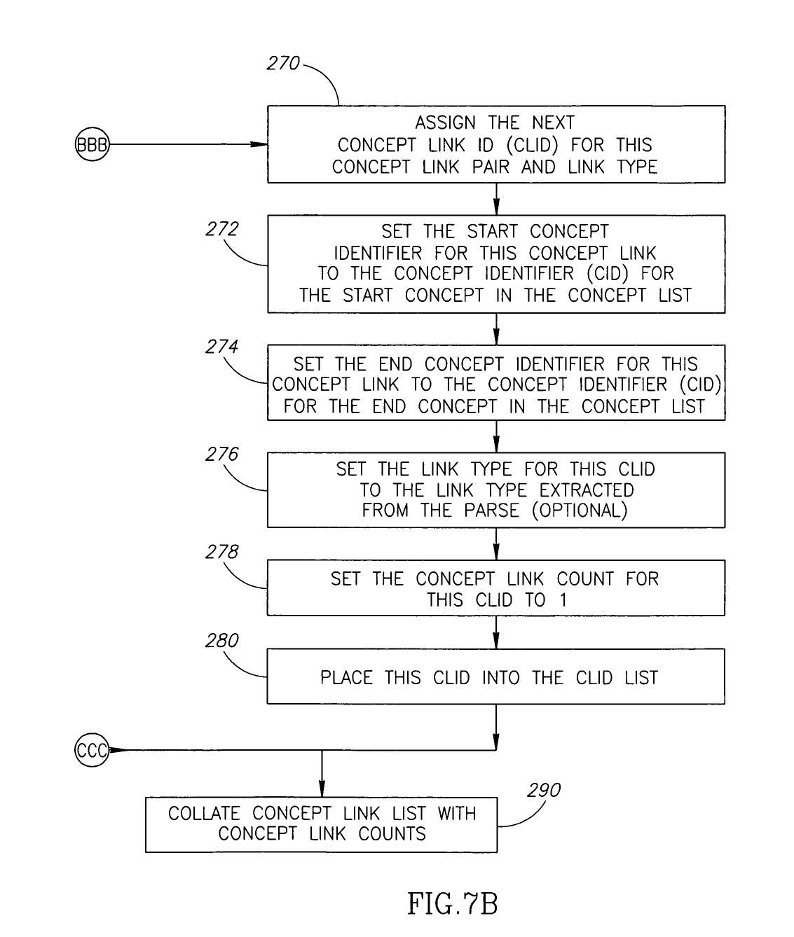

The list 110 is now subject to the process of box 112, where concept links are generated. The process of box 112, is shown in detail in the flow diagram of FIGS. 7A and 7B, to which attention is now directed.

At block 250, the concept list, such as the list 110, is received. This list 110 includes the concepts, concept senses, concept identifiers and concept counts, as detailed above. Concept counts are typically used to classify existing words into parts of speech not traditionally associated with these words, but whose usage may have changed in accordance with contemporary language.

The concept identifiers (CIDs) for each concept are linked in accordance with their pairing in the parse, and their link types or relational connectors (as assigned by the LGP), at block 252. Also, in block 252, the concept identifiers are linked in ordered pairs, for example (CIDX, CIDY), such that the left concept identifier, CIDX, is the start concept, and the right concept identifier, CIDY, is the end concept.

The process moves to block 254, where each set of ordered concept identifier (CID) pairs and their corresponding link type (relational connector), are provided as a query to the structured representation (SR) 42a for a prior existence of a corresponding normalized concept link. At block 256, a decision is made whether or not the requisite concept identifier (CID) pair and its link type (relational connector), have a corresponding start concept, end concept, and link type, for a concept link in the structured representation (SR) 42a.

If the concept pair matches a concept link in the structured representation (SR) 42a, the process moves to block 260. If the concept pair does not match any concept link in the structured representation (SR) 42a, the process moves to block 270.

At block 260, the concept link exists in the structured representation (SR) 42a. Accordingly, the concept link is returned to or placed into a concept link identifier (CLID) list 114, with the existing concept link identifier (CLID). The concept link count in the database, for example, the data store 42 or storage media linked thereto, for this existing concept link identifier (CLID) is increased by 1, at block 262. The process now moves to block 290.

Turning to block 270, the concept pair and link type do not exist as a concept link in the structured representation (SR) 42a. Accordingly, the concept pair and link type, are assigned the next available concept link identifier (CLID). This new concept link identifier (CLID) is assigned typically in ascending sequential order. At block 272, the start concept identifier for this concept link identifier (CLID) is set to the concept identifier (CID) for the start concept in the concept list 110. At block 274, the end concept identifier for this concept link identifier (CLID) is set to the concept identifier (CID) for the end concept in the concept list 110.

The process moves to block 276, where the link type for this concept link identifier (CLID) is set to the link type from the parse. For example, the parse is in accordance with the table 106 (detailed above). This sub process at block 276 is optional. Accordingly, the process may move directly from block 274 to block 278, if desired.

The concept link identifier (CLID) count, for this concept link identifier (CLID) is set to “1”, at block 278. The new concept link identifier (CLID) is placed into the list of concept link identifiers (CLIDs), such as the list 114, at block 280. The process moves to block 290.

At block 290, the concept link identifiers (CLIDs) with their corresponding concepts, concept senses, links types and concept links, are collated (arranged in a logical sequence, typically a first in, first out (FIFO) order) and provided as a completed list for the sentence, such as, for example, the list 114.

Each of the concept links of the list 114 is subject to validation, at box 116. Validation may use one or more processes. For example, the link validation process of box 116 may be performed by two functions, an IS_VALID_LINK function and a stop word function. The IS_VALID_LINK function and the stop word function are independent of each other. These functions are typically complimentary to each other.

The functions typically operate contemporaneous or near in time to each other. These functions can also operate on the list one after the other, with no particular order preferred. They can also operate simultaneously with respect to each other. Both functions are typically applied to the linked concepts of the list 114, before each link of the list 114 is placed into the resultant list, for example, the resultant list 118. However, it is preferred that both functions have been applied completely to the list 114, before the resultant list 118 has been completed.

The IS_VALID_LINK function is a process where concept links are determined to be valid or invalid. This function examines the concepts and their positions in the pair of linked concepts. This function is in accordance with three rules. These rules are as follows, in accordance with Boolean logic:

IF the end or second concept is a noun, THEN, make the concept link VALID; OR

IF the end or second concept is a verb, AND the start or first concept is a noun OR an adverb, THEN, make the concept link VALID; OR

OTHERWISE, make the concept link INVALID.

If the end or right concept is a noun, the concept link is always valid. However, if the end or right concept is a verb, the start or left concept must be either a noun or adverb, for the concept link to be valid. Otherwise, the concept link is invalid.

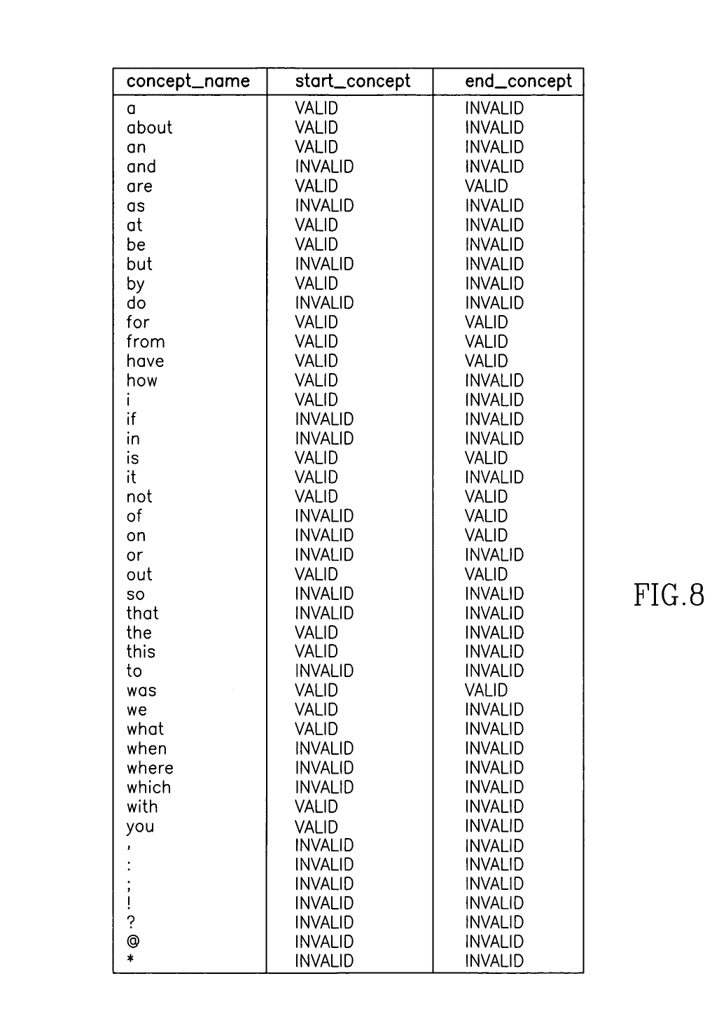

The stop word function is a function that only invalidates concept links. Stop words include, for example, words or concepts including portions of words, symbols, characters, marks, as defined above, as “words”, that based on their position, start concept or end concept, in the concept link, will either render the concept link valid or invalid. The stop words of the stop word function are provided in the Stop Word Table (or Table) of FIG. 8. In this Table, the stop words are listed as concepts.

Turning to an example, in the Table of FIG. 8, for an explanation of the Table, the word “a” is a concept. As indicated in the table, “a” is considered valid (VALID) in the start position (of an ordered pair of concepts) and invalid (INVALID) in the end position (of an ordered pair of concepts). This means that “a” is acceptable as the start concept of a concept link, but not acceptable as the end concept of concept link. If a concept link containing “a” in the start position is placed into a list, such as the list 118, it its validity value is not changed, since according to the Table, “a” is acceptable in the start position of a concept link. Alternatively, if “a” appears in the end concept position of a link, that link is rendered invalid, based on the INVALID entry in the Stop Word Table of FIG. 8, for the concept “a”.

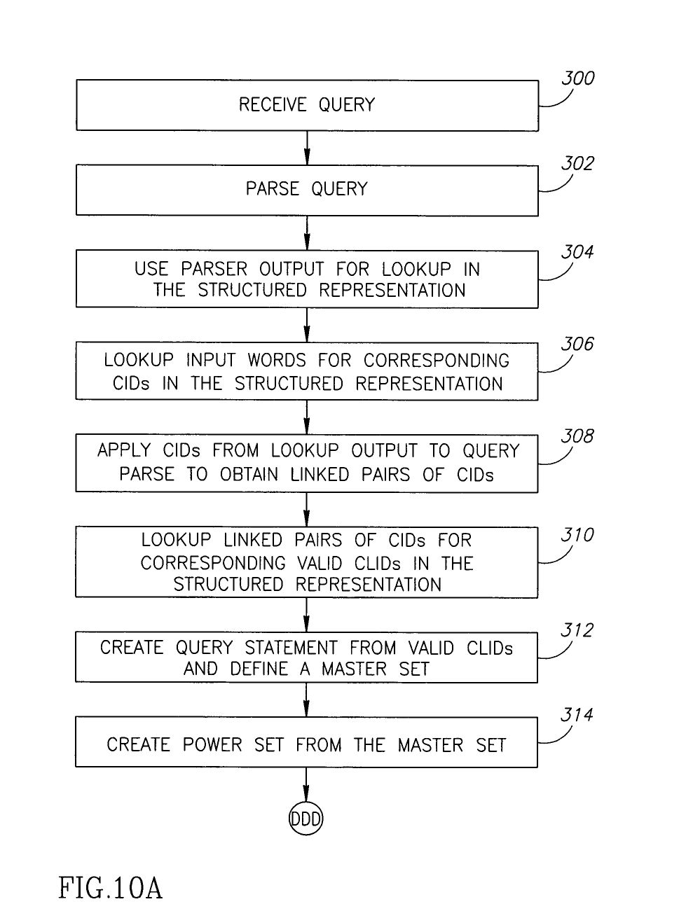

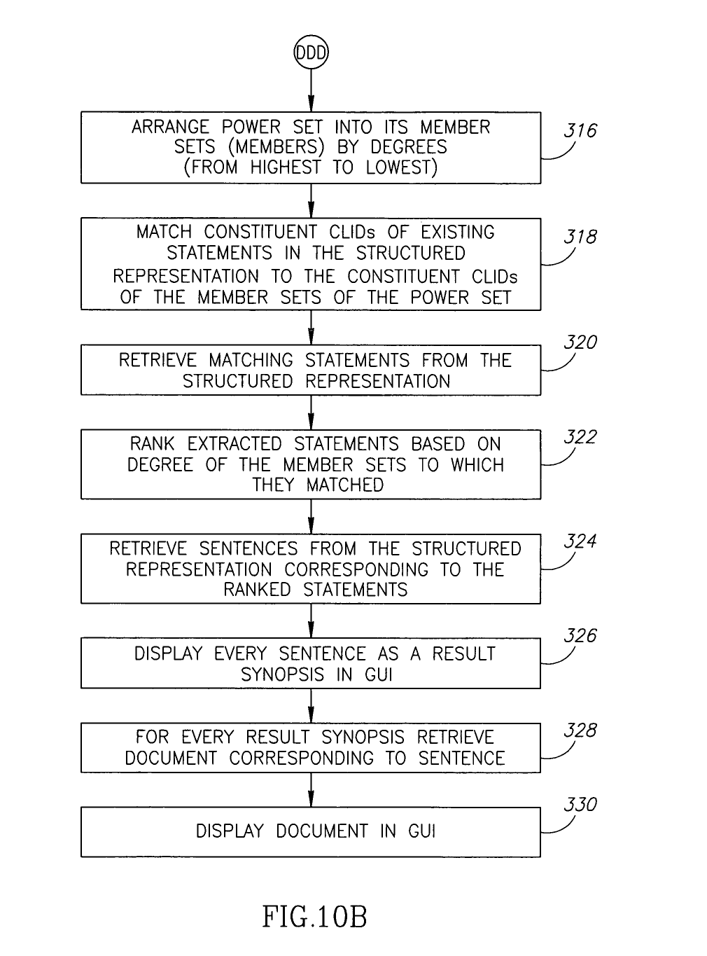

Concept links and their corresponding concept link identifiers (CLIDs), flagged as INVALID are maintained in the structured representation (SR) 42a. However, as detailed below, if this invalid concept link results from the parsed output of the query, the concept link identifier for an invalid concept link is not listed in the resultant query statement (blocks 310 and 312 of FIGS. 10A and 10B).

The concept links of the list 114 are then reformed into a list 118, with the concept links noted, for example, by being flagged, as either valid or invalid, as shown in the broken line box 119 (not part of the table 118 but shown for description purposes). These valid and invalid concept links are reexamined every time the link is seen. The concept link identifiers are then grouped to form a statement, at box server 120. A “statement”, as used in this document (as indicated above), is a set of concept links (concept link identifiers) that corresponds to a parse of a particular sentence (from its natural language). An exemplary statement formed from the list 118 is: {[CLID1] [CLID2] [CLID3] [CLID4] [CLID5]}, of box 120.

The statements represent syntactic relationships between the words in the sentences, and in particular, a collection of syntactic relationships between the words or concepts of the sentence from which they were taken. The statements, along with concepts, and concept links populate the structured representation (SR) 42a. The aforementioned process operates continuously on all of the sentences, for as long as necessary.

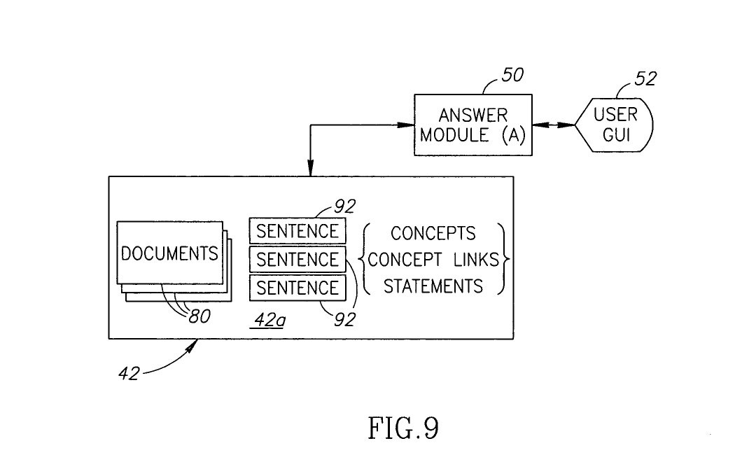

Attention is now directed to FIG. 9, an operational schematic diagram of the answer side of the architecture 40. The answer module (A) 50, takes a query submitted by a user, through an interface, such as a GUI 52. The answer module (A) 50 processes the query and extracts the important linguistic structures from it. In performing the processing, the answer module (A) 50 creates relational components of the query, that are based on the relationships of the words to each other in natural language, in the query. Within the answer module (A) 50 is a parser, for example, the above described LGP.

The parser, for example, the LGP, extracts linguistic structures from the query, and outputs the query, similar to that detailed above, for the database population side. The answer module (A) 50 then requests from the data store 42, sentences and their associated documents, that contain the linguistic structures just extracted. These extracted linguistic structures, encompass answers, that are then ranked in accordance with processes detailed below. Finally, the answer module (A) 50 sends the answers to the GUI 52 associated with the user who submitted the query, for its presentation to the user, typically on the monitor or other device (PDA, iPAQ, cellular telephone, or the like), associated with the user.

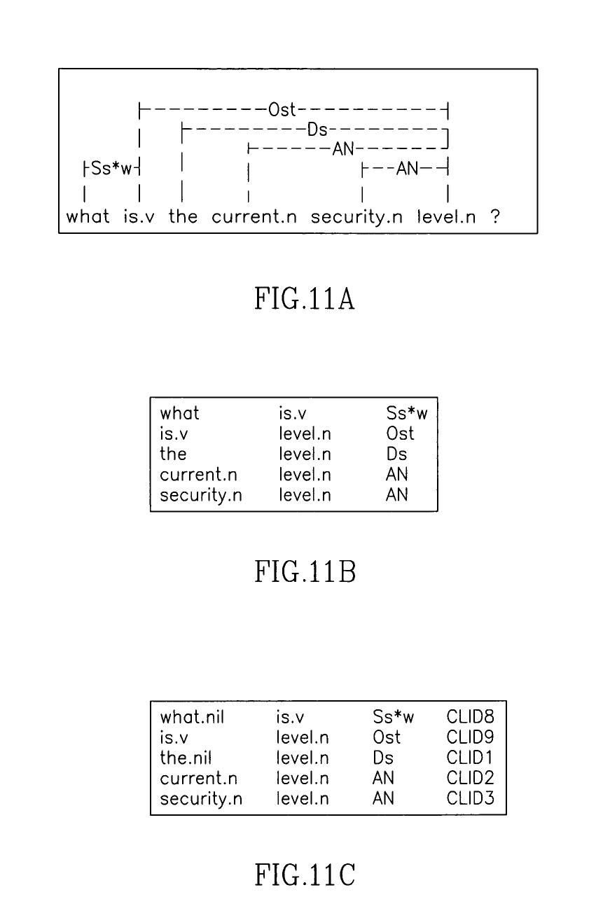

Turning also to FIGS. 10A, 10B, and 11A-11C, an exemplary process performed by the answer module (A) 50 in the server 20 (and associated architecture 40) is now detailed. Initially, the data store 42, and its structured representation (SR) 42a, has been populated with data, for example, statements, concepts and concept links concepts, as detailed above, and for purposes of explanation, such as that shown in FIGS. 5A-8 and detailed above.

The answer module (A) 50 receives a query, entered by a user or the like, in natural language, through an interface, such as the GUI 52, at block 300. An exemplary query may be, “What is the current security level?“

The answer module (A) 50 utilizes the LGP to parse the query at block 302. The output of parsing by the LGP is in accordance with the parsing detailed above, and is shown for example, in FIG. 11A. An exemplary parse of the question would yield the words “what”, “is”, “the”, “current”, “security” and “level”, including concept senses and links between the words, as shown in the Table of FIG. 1B.

The parser output, for example, as per the Table of FIG. 11B, is used for lookup in the structured representation (SR) 42a of the data store 42, for concept identifiers, at block 304. Also in block 304, words of the output are matched with previously determined concept identifiers of the structured representation (SR) 42a. In block 306, the words and their concept senses that form the list (or portions of words and their labels) are assigned concept identifiers (CIDs), in accordance with the concept identifiers (CIDs) that have been used to populate the structured representation (SR) 42a of the data store 42. However, if an inputted word of the query does not have an existing corresponding concept identifier, a concept identifier is not returned, and if part of a linked pair, the pair will not receive a concept link identifier (CLID).

The inputted words, having been assigned concept identifiers (CIDs), are linked in pairs, as per the query parse (FIGS. 11A and 11B), at block 308. For example, the former word and now concept “is” receives CID5. Similarly, “the” receives CID1, “current” receives CID3, “security” receives CID4 and “level” receives CID2.

The linked pairs of concept identifiers are then subject to lookup for corresponding valid concept link identifiers (CLIDs) in the structured representation (SR) 42a of the data store 42, at block 310. For example, this sub process would yield the valid concept link identifiers CLID9, CLID1, CLID2 and CLID3, from the table of FIG. 11C. For example, CLID8 was designated invalid upon populating the data store 42, for example, at box 116 of FIGS. 5A and 5B. (For example, CLID8 and CLID9 were also in the structured representation (SR) 42a, previously stored in the data store 42).

A query statement from the valid concept link identifiers is created at block 312. Throughout this document (as indicated above), a query statement is a set of concept links (concept link identifiers) that correspond to the parse of the query. For example, the query statement from the concept link identifiers is as follows: [CLID9] [CLID1] [CLID 2] [CLID3]. The statement represents syntactic relationships between the words in the query, and in particular, a collection of syntactic relationships between the words.

All of the valid concept link identifiers (CLIDs) from the query statement, define a master set, expressed as {[CLID9], [CLID1], [CLID2], [CLID3]}, also at block 312. A power set is created from the master set, at block 314. The “power set”, as used herein (as indicated above) is written as the function P(S), representative of the set of all subsets of “S”, where “S” is the master set. Accordingly, if the query statement includes four concept link identifiers (CLIDs), the size of “S” is 4 and the size of the power set of “S” (i.e., P(S)) is 2⁴ or 16.

At block 316, the power set from the master set (from the query statement): {[CLID9], [CLID1], [CLID2], [CLID3]}, is as follows:

{{[CLID9], [CLID1], [CLID2], [CLID3]}, {[CLID9], [CLID1], [CLID2]}, {[CLID9], [CLID1], [CLID3]}, {[CLID9], [CLID2], [CLID3]}, {[CLID1], [CLID2], [CLID3]}, {[CLID9], [CLID1]}, {[CLID9], [CLID2]}, {[CLID9], [CLID3]}, {[CLID1], [CLID2]}, {[CLID1], [CLID3]}, {[CLID2], [CLID3]}, {[CLID9]}, {[CLID1]}, {[CLID2]}, {[CLID3]}, { }}.

Also in block 316, the members (individual sets) of the power set are arranged in order of their degree. Throughout this document (as indicated above), “degree” or “degrees” refer(s) to the number of concept links in a set. The members of the power set are typically ranked by degree in this manner. In this case, for a query statement with four concept link identifiers (CLIDs), degree 4 is the highest rank, as it includes four concept link identifiers (CLIDs) in this particular collection. Similarly, degree 1 is the lowest, as it includes one concept link identifier (CLID) per collection. While the empty set, of degree zero, is a member of the power set, it is typically not used when arranging the power set.

The power set consists of subsets of the master set, that are ordered by degree and ranked in accordance with the following table:

| | |
|---|---|
| Degree 4 | {[CLID9], [CLID1], [CLID2], [CLID3]} |
| Degree 3 | {[CLID9], [CLID1], [CLID2]}, {[CLID9], [CLID1], |
| | [CLID3]}, {[CLID9], [CLID2], [CLID3]}, {[CLID1], |
| | [CLID2], [CLID3]} |
| Degree 2 | {[CLID9], [CLID1]}, {[CLID9], [CLID2]}, {[CLID9], |
| | [CLID3]}, {[CLID1], [CLID2]}, {[CLID1], [CLID3]}, |
| | {[CLID2], [CLID3]} |
| Degree 1 | {[CLID9]}, {[CLID1]}, {[CLID2]}, {[CLID3]} |

The members in the power set are now matched against the statements in the structured representation (SR) 42a, by comparing their concept link identifiers (CLIDs), at block 318. The comparison starts with analysis of the highest (degree 4) member, and goes in descending sequential order, to the lowest (degree 1) member. The answer module (A) 50 performs a comparator function that compares concept link identifiers (CLIDs) in the statements to the concept link identifiers (CLIDs) of the members of the power set, and a matching function, determining if there is a match between the all of the concept link identifiers (CLIDs) of any of the members of the power set, and one or more concept link identifiers (CLIDs) in the statements of the structured representation (SR) 42a. If a statement (from the structured representation (SR) 42a ) contains all of the concept link identifiers (CLIDs), that are also contained in a member of the power set, there is a “match”, and the statement is not examined or used again. A statement matching a set of degree 4 will be a statement with four matching concept link identifiers, although the statement may include more than four concept link identifiers (CLIDs). Similarly, a statement matching a set of degree 3, degree 2 or degree 1, would be determined in the same manner.

The matching statements are retrieved or pulled from the structured representation (SR) 42a by the answer module (A) 50, at block server 320. The retrieved statements are assigned a rank based on the degree of the ordered set that they match, at block 322.

Typically, the statement of the highest degree will be listed as the highest result. The statement of the next highest degree will be considered as the next highest result. Listings may be for as many results as desired. Alternately, if there are not any matches, a result may not be returned.

Sentences, corresponding to the retrieved statements, are retrieved from the structured representation (SR) 42a, at block 324. At block 326, each retrieved sentence is displayed on the GUI 52 as a result synopsis. A document is retrieved for every result synopsis selected by the user or the like, from which the sentence is a part of, at block 328. The document is ultimately displayed in the GUI 52, at block 330.

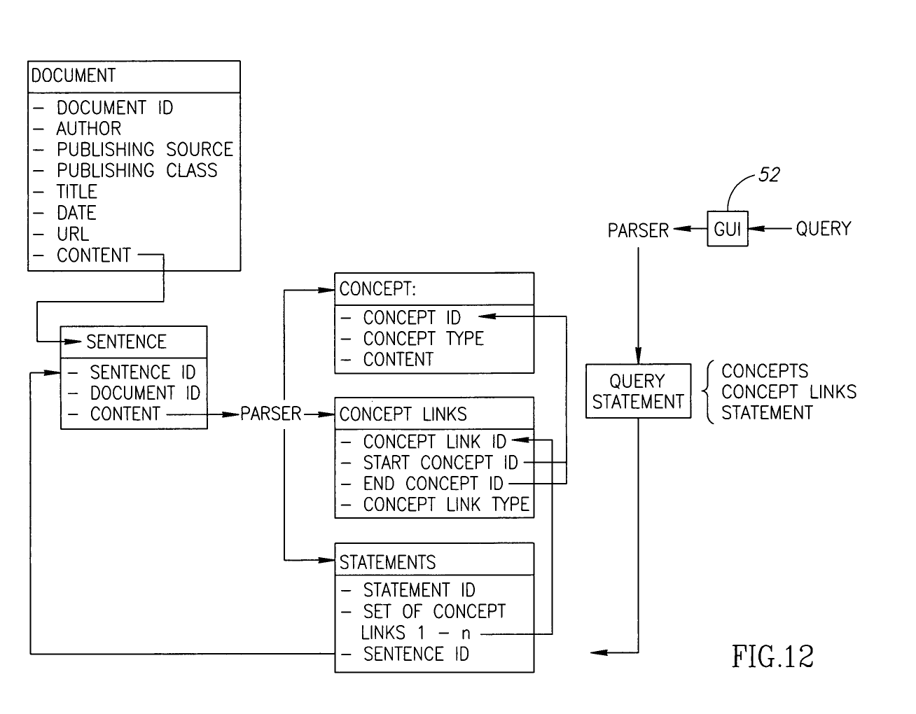

FIG. 12 shows a chart of a statement ultimately leading to sentences and documents, as per blocks 324, 326 and 328. Once a statement has been determined to be the result. A lookup is performed on the structured representation (SR) 42, to retrieve the sentence corresponding to the statement. There is a one to one relation between statements and sentences. The sentences are then used to identify the document from which they came.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for analyzing a query, comprising:
receiving a query in natural language; and
providing at least one response to the query in accordance with the relationships of the words to each other in natural language, of the query.

2. The method of claim 1, wherein providing the at least one response to the query includes, providing at least one representation of a corpus, the corpus including text in natural language, based on the relationships of words to each other in natural language.

3. The method of claim 2, wherein providing the at least one response to the query includes, creating relational components of the query in accordance with the relationships of the words to each other in the natural language of the query.

4. The method of claim 3, wherein providing the at least one response to the query includes, matching the relational components of the query to a portion of the representation of corpus.

5. The method of claim 4, wherein the matching includes, isolating the portion of the representation of the corpus.

6. The method of claim 5, wherein the at least one response to the query includes at least one sentence from the text of the corpus corresponding to the isolated portion of the representation of the corpus.

7. A search engine comprising:
a first component configured for receiving a query in natural language; and
a second component configured for providing at least one response to the query in accordance with the relationships of the words to each other in natural language, of the query.

8. The search engine of claim 7, wherein the second component includes a first module configured for providing at least one representation of a corpus, the corpus including text in natural language, based on the relationships of words to each other in natural language.

9. The search engine of claim 8, wherein the second component includes a second module configured for creating relational components of the query in accordance with the relationships of the words to each other in the natural language of the query.

10. The search engine of claim 9, wherein the second module is additionally configured for, matching the relational components of the query to a portion of the representation of corpus.

11. The search engine of claim 10, wherein the second module is additionally configured for isolating the portion of the representation of the corpus.

12. The search engine of claim 11, wherein the first module is additionally configured for providing at least one sentence from the text of the corpus corresponding to the isolated portion of the representation of the corpus.

13. A method for isolating data from a corpus, comprising:
processing at least a portion of the corpus into at least one first collection of syntactic relationships;
processing at least one query into at least one second collection of syntactic relationships; and,
comparing the at least one second collection of syntactic relationships to the at least one first collection of syntactic relationships.

14. The method of claim 13, additionally comprising: receiving at least one inputted query.

15. The method of claim 13, wherein processing at least a portion of the corpus includes, receiving feeds and isolating documents from the feeds.

16. The method of claim 15, wherein processing at least a portion of the corpus includes, isolating individual sentences from the documents.

17. The method of claim 16, wherein processing the corpus includes, parsing each sentence into at least one syntactic relationship.

18. The method of claim 17, wherein processing the corpus includes, ordering the at least one syntactic relationship into the at least one first collection of syntactic relationships.

19. The method of claim 18, wherein at least one syntactic relationship includes,
a plurality of syntactic relationships; and,
ordering the at least one syntactic relationship includes, ordering the plurality of syntactic relationships into the at least one first collection of syntactic relationships.

20. The method of claim 19, wherein the at least one first collection of syntactic relationships includes, a plurality of first collections of syntactic relationships.

21. The method of claim 13, wherein comparing includes, matching the at least one second collection of syntactic relationships to the at least one first collection of syntactic relationships, and, if there is a match, isolating the at least one first collection of syntactic relationships.

22. The method of claim 21, additionally comprising:
providing a response to the at least one query by providing the sentence corresponding to the at least one first collection of syntactic relationships.

23. The method of claim 22, wherein providing the response includes, providing access to the document from which the sentence corresponding to the at least one set of syntactic relationships was isolated.

24. A method for providing at least one response to at least one query in natural language, comprising:
populating a data store by obtaining documents from at least a portion of a corpus, isolating sentences from the documents, parsing the sentences into linked pairs of words in accordance with predetermined relationships, assigning concept identifiers to each word of the linked pair of words, assigning concept link identifiers to each pair of concept identifiers corresponding to each linked pair of words, and, combining the concept link identifiers for each sentence into a statement;
receiving an inputted query in natural language;
parsing the query into linked pairs of words in accordance with predetermined relationships, assigning concept identifiers to each word of the linked pair of words, assigning concept link identifiers to each pair of concept identifiers corresponding to each linked pair of words, and, combining the concept link identifiers into a query statement;
analyzing the query statement and the statements in the data store for matches between concept link identifiers;
isolating statements in the data store having at least one concept link identifier that matches at least one concept link identifier in the query statement; and,
providing at least one sentence corresponding to at least one isolated statement in the data store as a response to the natural language query.

25. The method of claim 24, additionally comprising: providing access to at least one document from which the at least one sentence, corresponding to the at least one matched statement, was isolated.

26. The method of claim 24, wherein the predetermined relationships are defined by a parser.

27. The method of claim 24, wherein isolating statements in the data store includes, isolating statements in the data store having the greatest number of concept links that match the greatest number of concept links in the query statement.

28. The method of claim 24, wherein assigning concept identifiers to each word of the query includes, performing a lookup in the data store for the concept identifier matching the word from the query.

29. The method of claim 28, wherein assigning concept link identifiers includes, performing a lookup in the data store for paired concept identifiers matching the paired concept identifiers from the query.

30. A method for analyzing a query to a search engine, comprising:
creating related pairs of words in the query;
assigning concept identifiers to the each of the words in each of the related pairs of words;
creating pairs of concept identifiers by applying the assigned concept identifiers to each word in the related pairs of words;
assigning concept link identifiers to each pair of concept identifiers; and,
combining all of the concept link identifiers into a query statement.

31. The method of claim 30, wherein all of the concept link identifiers of the query statement define a master set, where N is the number of concept link identifiers in the master set; and,
creating a power set from the master set including, creating a plurality of subsets from the master set, the plurality of subsets defining members of the power set, the power set including at least one member of N concept link identifiers and at least N members of one concept link identifier.

32. The method of claim 30, wherein the creating related pairs of words includes, parsing the query in a parser.

33. The method of claim 31, additionally comprising: analyzing a plurality of stored statements, the stored statements formed of a plurality of concept link identifiers, with the members of the power set, the analysis including, determining matches of the concept link identifiers in the stored statements with all of the concept link identifiers in each member of the power set.

34. The method of claim 33, additionally comprising: isolating stored statements with concept link identifiers that match all of the concept link identifiers in a member of the power set.

35. The method of claim 34, wherein the stored statements with the greatest number of concept links, matching all of the concept links in the member of the power set with the greatest number of concept links, are assigned the highest rank.

36. The method of claim 35, wherein at least one stored statement of the highest rank is isolated.

37. The method of claim 36, wherein the at least one isolated stored statement is determined to be a response to the query.

38. The method of claim 37, wherein the at least one isolated stored statement corresponds to at least one sentence of a document, and, the at least one sentence is returned to a predetermined location.

39. The method of claim 38, wherein access to the document that included the at least one sentence is provided at the predetermined location in association with the returned sentence.

40. A method for analyzing a query to a search engine, placed in natural language, comprising:
creating related pairs of words from the natural language of the query;
assigning concept identifiers to the each of the words in each of the related pairs of words;
creating pairs of concept identifiers by applying the assigned concept identifiers to each word in the related pairs of words;
assigning concept link identifiers to each pair of concept identifiers; and,
combining all of the concept link identifiers into a query statement.

41. The method of claim 40, wherein all of the concept link identifiers of the query statement define a master set, where N is the number of concept link identifiers in the master set; and,
creating a power set from the master set including, creating a plurality of subsets from the master set, the plurality of subsets defining members of the power set, the power set including at least one member of N concept link identifiers and at least N members of one concept link identifier.

42. The method of claim 40, wherein the creating related pairs of words includes, parsing the query in a parser.

43. The method of claim 41, additionally comprising: analyzing a plurality of stored statements, the stored statements formed of a plurality of concept link identifiers, with the members of the power set, the analysis including, determining matches of the concept link identifiers in the stored statements with all of the concept link identifiers in each member of the power set.

44. The method of claim 41, additionally comprising: isolating stored statements with concept link identifiers that match all of the concept link identifiers in a member of the power set.

45. The method of claim 44, wherein the stored statements with the greatest number of concept links, matching all of the concept links in the member of the power set with the greatest number of concept links, are assigned the highest rank.

46. The method of claim 45, wherein at least one stored statement of the highest rank is isolated.

47. The method of claim 46, wherein the at least one isolated stored statement is determined to be a response to the query.

48. The method of claim 47, wherein the at least one isolated stored statement corresponds to at least one sentence of a document, and, the at least one sentence in natural language and the at least one sentence is returned to a predetermined location.

49. The method of claim 48, wherein access to the document that included the at least one sentence is provided at the predetermined location in association with the returned sentence.

50. A method for identifying a document from syntactic relationships:
electronically maintaining a document database identifying documents;
electronically maintaining a sentences database identifying sentences of each of the documents;
electronically maintaining a syntactic relationships database identifying collections of syntactic relationships between pairs of words formed from the words of each of the sentences; and,
electronically linking the document database, the sentences database and the syntactic relationships data base, such that when at least one collection of syntactic relationships is isolated, the corresponding sentence in the sentence database is isolated, and the corresponding document in the document database is isolated from the isolated sentence in the sentence database.

51. The method of claim 50, wherein the collections of syntactic relationships define statements.

52. The method of claim 51, wherein the statements include concept link identifiers, the concept link identifiers based on pairs of concept identifiers.

53. The method of claim 52, wherein each word of each pair of words includes a corresponding concept identifier.

54. An architecture for isolating data from a corpus, comprising:
at least one data storage unit including at least one database;
a database population module in communication with the at least one data storage unit, the database population module configured for;
processing at least a portion of the corpus into at least one first collection of syntactic relationships; and,
storing the at least one first collection of syntactic relationships in the at least one data storage unit; and,
an answer module in communication with the at least one data storage unit, the answer module configured for;
processing at least one query into at least one second collection of syntactic relationships; and,
comparing the at least one second collection of syntactic relationships to the at least one first collection of syntactic relationships.

55. The architecture of claim 54, additionally comprising: a graphical user interface in communication with the answer module for receiving at least one inputted query.

56. The architecture of claim 54, wherein the database population module includes, at least one retrieval module configured for receiving feeds, and, at least one feed module, in communication with the at least one retrieval module, the at least one feed module configured for isolating documents from the feeds.

57. The architecture of claim 56, wherein the database population module includes, at least one document module in communication with the at least on feed module, the at least one document module configured for isolating individual sentences from the documents.

58. The architecture of claim 57, wherein the database population module includes, at least one sentence module in communication with the at least one document module, that at least one sentence module configured for;
parsing each sentence into at least one syntactic relationship; and
ordering the at least one syntactic relationship into the at least one first collection of syntactic relationships.

59. The architecture of claim 58, wherein the answer module configured for comparing the at least one second collection of syntactic relationships to the at least one first collection of syntactic relationships is additionally configured for;
matching the at least one second collection of syntactic relationships to the at least one first collection of syntactic relationships; and,
if there is a match, isolating the at least one first collection of syntactic relationships.

60. The architecture of claim 59, wherein the answer module is additionally configured for providing a response to the at least one query by providing the sentence corresponding to the at least one first collection of syntactic relationships, from the at least one data storage unit.
